(19) United States
(12) Patent Application Publication
(10) Pub. No.: US 2003/0030908 A1
(43) Pub. Date: Feb. 13, 2003

(54) Virtually imaged phased array (VIPA) with machined radiation window boundary

(76) Inventors: Yeou-Yen Cheng, Saratoga, CA (US); Ying-Moh Liu, Saratoga, CA (US); Cheng-Hsi Miao, San Jose, CA (US); Tan C. Mac, San Jose, CA (US)

Correspondence Address: Dr. Yeou-Yen Cheng, Vice President of Research and Development, Baynet Optics Nutech PMB 545, 1072 S. De Anza Blvd. Suite A107, San Jose, CA, 95129, US

(21) Appl. No.: 09/929,861

(22) Filed: Aug. 13, 2001

(51) Int. Cl. G02F 1/03; G02F 1/07; G02B 27/00

(52) U.S. Cl. 359/577; 359/260

(57) ABSTRACT

A Virtually Imaged Phased Array (VIPA) contains a separate, precision-machined optical surface that forms one surface of the internal etalon and a boundary of the “radiation window,” in order to more easily achieve the optical-mechanical tolerances necessary for desired performance. VIPA design known to the prior art requires that a high reflective (mirror) optical coating be applied to a portion of a face of a plate of glass with a very sharp and well controlled boundary line across the surface while the remainder has an AR coating. This is difficult under the state of the art. In the disclosed VIPA, the required sharp boundary can be the machined physical edge of a plate of material (instead of the edge of a coating), which can be very precisely cut and controlled using common optical techniques. The disclosed VIPA is more easily manufactured than those known to the state of the art, and therefore is practical for applications such as the dispersing element in a chromatic dispersion compensator.

### BACKGROUND

1. Field Of Invention

This invention relates to dispersing optical devices used in fiber optic communications and in particular to a Virtually Imaged Phased Array (VIPA).

2. Discussion Of Related Art

Many fiber optic communication systems transmit multiple or single optical signals through a single optical fiber. Multiple signals can be transmitted with pulses of light with different wavelengths (colors) in a wavelength division multiplexing (WDM) or dense wavelength division multiplexing (DWDM) transmission. A single optical signal, often with relatively wide optical bandwidth, can also be transmitted on a single fiber.

Light travels at a slower speed through matter than it does in a vacuum. The index of refraction (index) of a material is the ratio of the speed of light in vacuum to the speed of light in the material: the larger the index, the slower light travels through the material. A majority of optical materials have an index that varies with the wavelength of light. The variation of index with wavelength causes light of different wavelengths transmitted through the material to become temporally or spatially separated, an effect called “dispersion.” Most materials generate dispersion because the index of refraction is lower (speed of light is higher) for longer wavelengths (red-infrared) and such that the index of refraction is higher (speed of light is slower) for shorter wavelengths (blue-ultraviolet). As an example, it is the dispersion of light in glass that allows a prism to produce a spectrum of colors from white light. The spreading of different wavelengths (colors) of light over different angles is termed “angular dispersion.”

Dispersion presents a problem for optical fiber communications where a set of signals of different wavelengths (or one signal with a broad bandwidth) are sent down a very long fiber (e.g., 100 km). Because the different wavelengths of light travel though the fiber material at different speeds due to dispersion, signals at one wavelength may arrive significantly before signals of another wavelength or a single signal (of a finite optical bandwidth) is spread out in time. The spreading of the signal(s) in arrival time is called “chromatic dispersion” and is detrimental to communication system performance.

In certain fiber optics, particularly single mode fibers, dispersion is a function of fiber geometry as well as the native material properties of the fiber. It is thus common to have a fiber optic with a dispersion opposite to that of the native material, at least over a region of wavelengths, such that longer wavelength light travels more slowly through the fiber rather than more rapidly. This case will be further addressed in the following discussion.

If a fiber optics transmits longer wavelengths at a slower speed than shorter wavelengths, then the resulting chromatic dispersion can be corrected by a device that passes long wavelengths more quickly than short wavelengths (the opposite of the fiber). In one type of chromatic dispersion corrector, angular dispersion is used to make beams of different wavelengths take shorter or longer paths through an optical system.

A Virtually Imaged Phased Array (VIPA) is an optical device that can produce a very large angular dispersion. A VIPA might produce a dispersion of 0.5°/nm instead of 0.05°/nm for a grating (see M. Shirasaki, Virtually Imaged Phased Array) or 0.005°/nm for a typical prism (see The Optics Problem Solver, pp. 677-8). The VIPA's large dispersion makes it very useful in a chromatic dispersion corrector by making it easier to physically separate light of relatively close wavelengths. FIGS. 1A and 1B show a schematic of a chromatic dispersion corrector that uses a VIPA as a dispersing component.

In FIG. 1A, light 10 is collected from the end of an optical fiber 1 and converted to a converging beam 11 by fiber coupling optics 20 directed towards a line focus 16 in VIPA 30. While VIPA 30 is a dispersing component, like a prism or diffraction grating, its angular dispersion 63 (separating shorter wavelength light 12 from longer wavelength light 13) is often much greater than for most other dispersing components. VIPA 30 converts converging beam of light 11 to collimated beams of light 12 and 13 separated by an angle 63 that is a function of their wavelengths. The virtual images lie along line 90. Note that while the VIPA actually produces several different orders (groups) of such beams, only two, beams 12 and 13, are shown for simplicity. In some embodiments, mirror 41 is sized to eliminate all but one order.

Beams 12 and 13 are received in path optics 40. Path optics 40 sends shorter wavelength (faster) light 12 on a longer path 82 while longer wavelength (slower) light 13 takes shorter path 81, thus giving the longer wavelength light a chance to catch up. The light travelling paths 81 and 82 is reflected by mirror 41 (which also serves to eliminate all except one desired order) and travels back through the system in reverse, as shown in FIG. 1B. Because of the reversibility of optical systems, when the light re-renters VIPA 30 travelling backwards along its original path, it is reassembled again into line focus 16 and is output as a diverging beam 14. This beam is collected by fiber-coupling optics 20, and focussed into converging beam 15 directed back into fiber 1 with the longer wavelength optical signals adjusted for the chromatic dispersion suffered in fiber 10.

VIPA 200, shown in FIGS. 2A and 2B, is a specialized optical etalon, which is well known in the literature (see e.g., E. Hecht, Optics). VIPA 200 includes two flat surfaces 53 and 55 which cause light entering etalon gap 56 between them to undergo multiple reflections between surfaces 53 and 55 resulting in angular dispersion of the output beams over several orders. One output beam 61 of one order is shown in FIG. 2A. The term Virtually Imaged Phased Array derives from the fact that where in each of the multiple reflections a transmitted ray 19 exits partially transmitting coating 55, a virtual image 83 of line focus 16 is created. The multiplicity of virtual images 83 acts as a phased array to produce several orders of dispersed beams; one wavelength of one order is shown as output beam 61.

VIPA 200 is formed from one plate 50. First face 51 of plate 50 has a reflective coating 53 on one portion (about half), with the remainder coated by antireflective (AR) coating 52 to allow light to enter etalon gap 56. A lateral boundary 57 is formed between reflective coating 53 and antireflective coating 52. The most efficient dispersion by VIPA 200 is achieved when light entering etalon gap 56 strikes partially transmitting coating 55 at the smallest possible value of incidence angle 210 in order to allow the largest possible number of multiple reflections. For this condition to occur without any light missing reflective coating 53 (and being lost), lateral boundary 57 must be extraordinarily sharp.

Converging beam of light 11 enters VIPA 200 though an area of AR coating 52 called the “radiation window” 58, missing 100% reflective (mirror) coating 53. Back face 54 of plate 50 forming VIPA 200 is coated with partially transmitting coating 55. Converging light beam 11 comes to line focus 16 at back face 54 of plate 50. Most of the light energy is contained in reflected beam 18 directed towards reflective coating 53 and undergoes multiple reflections. On each reflection (including the first), a small part of the energy is carried in a transmitted beam 19 through partially transmitting coating 55.

As a result of optical interference of the multiplicity of transmitted beams 19 that have passed through partially transmitting coating 55 on each of the multiple reflections, a set of orders of diffraction are created. One wavelength of beam of one order is shown as collimated beam 61, being produced at its own (wavelength-dependent) angle 62 from optical axis 17. The optical interference resulting in beam 61 is further discussed in M. Shirasaki, Virtually Imaged Phased Array.

In practice, because of the stringent requirements on reflective coating 53 to antireflective coating 52 boundary 57 on first face 51, shown face-on in FIG. 2B, it is difficult to economically manufacture the quantity and quality of VIPAs required for commercial fiber optical system use. Lateral edge 57 can be formed, for example, by photo etching or by mechanical shaving. However, these techniques do not lead to inexpensive and large-scale production of VIPAs.

Therefore, there is a need for a Virtually Imaged Phased Array that is easily manufactured in large scale.

### SUMMARY OF THE INVENTION

In accordance with the present invention, a Virtually Imaged Phased Array (VIPA) is disclosed which is easily and cheaply manufactured. In some embodiments, the VIPA includes a transmitting plate with an anti reflective coating (the first component), a reflective plate with a reflective coating (the second component), and a partially transmitting plate with a partially transmitting coating (the third component). The first and third components are positioned relative to one another to form a gap. The second component is positioned within the gap such that light reflected from the third component is reflected by the second component back onto the third component, forming an etalon gap between the second component and the third component. In some embodiments of the invention, the first component may be eliminated.

Constructing the first component and the second component from different physical components obviates the need for a highly precise lateral boundary between a reflective coating and an antireflective coating. The precision boundary is now controlled by the physical edge of the second component instead of a lateral boundary across a film. Therefore VIPAs can be manufactured with standard and affordable optical fabrication techniques such as cutting, polishing, and coating to achieve the tolerances required for acceptable VIPA performance.

These and other embodiments are further discussed below with respect to the following claims.

### BRIEF DESCRIPTION OF FIGURES

FIGS. 1A and 1B (prior art) show a schematic diagram of a chromatic dispersion corrector.

FIGS. 2A and 2B (prior art) show a conventional VIPA design.

FIGS. 3A, 3B, and 3C show an embodiment of a VIPA according to the present invention.

FIG. 4 shows light entering and exiting a VIPA.

FIG. 5 shows another embodiment of a VIPA according to the present invention.

FIGS. 6A and 6B show another embodiment of a VIPA according to the present invention.

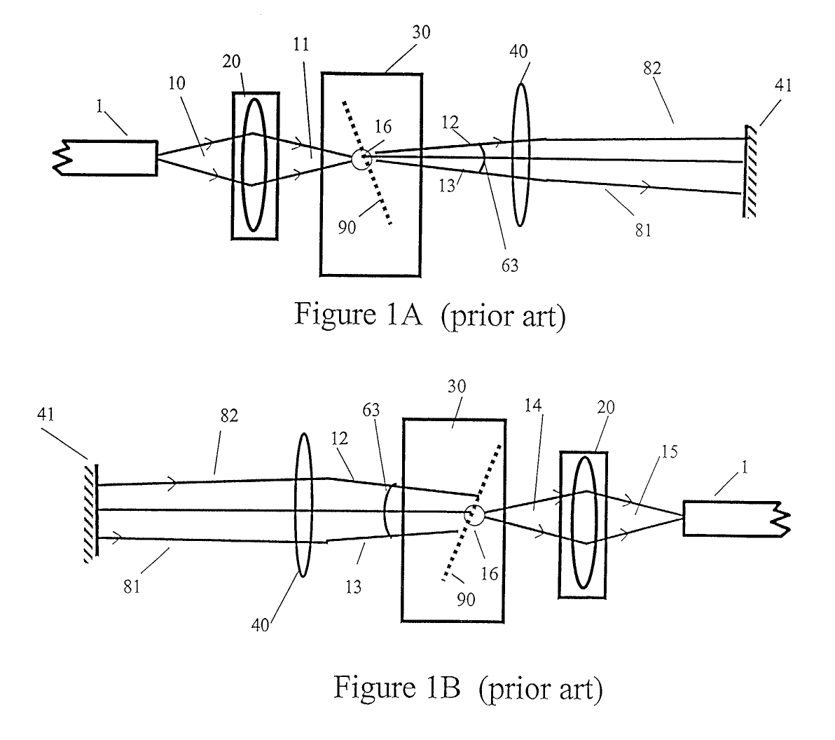

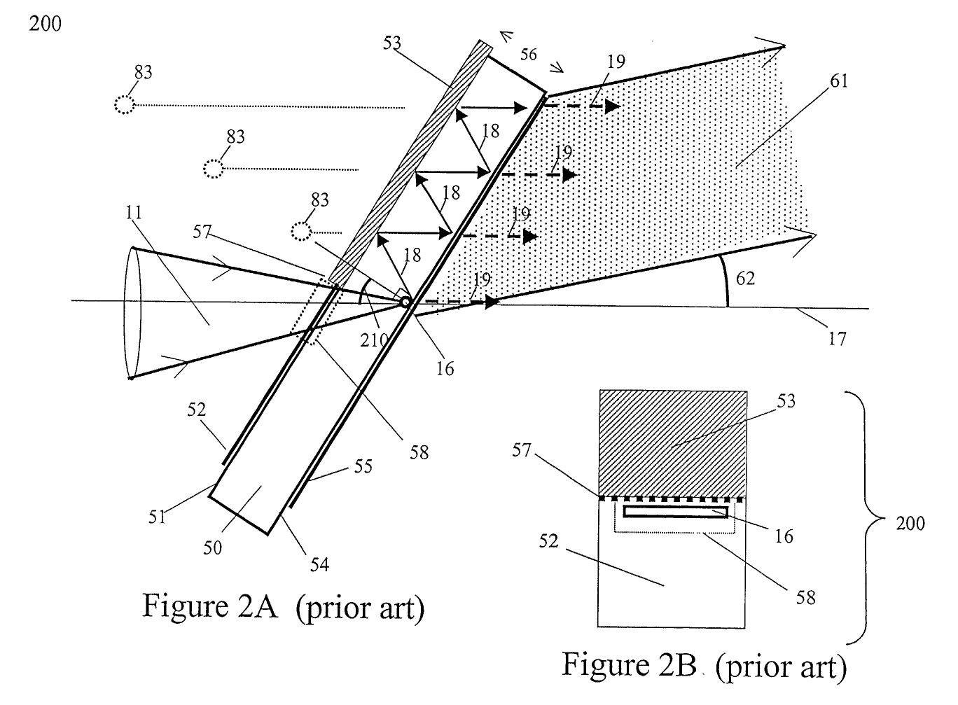

### DETAILED DESCRIPTION

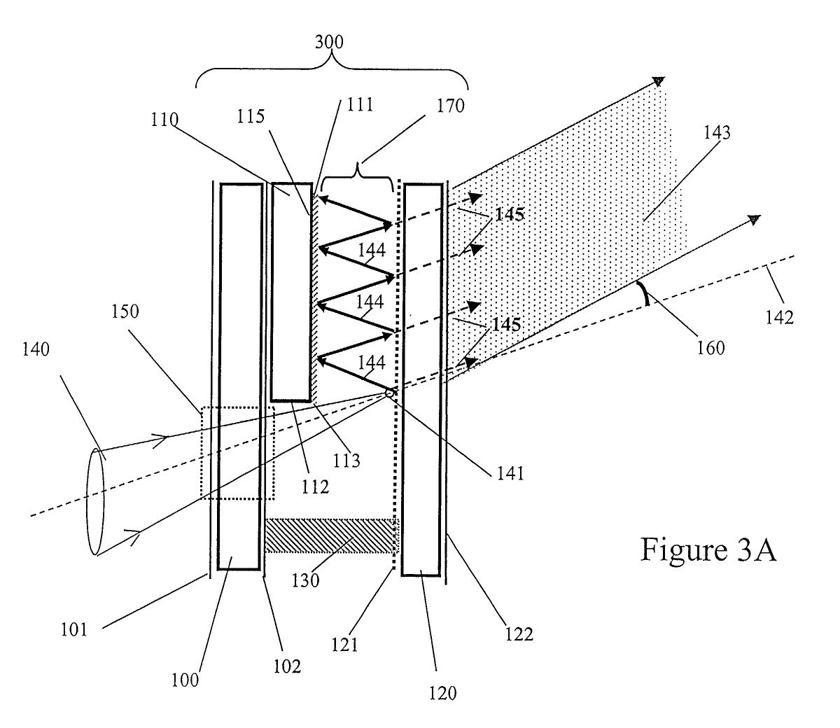

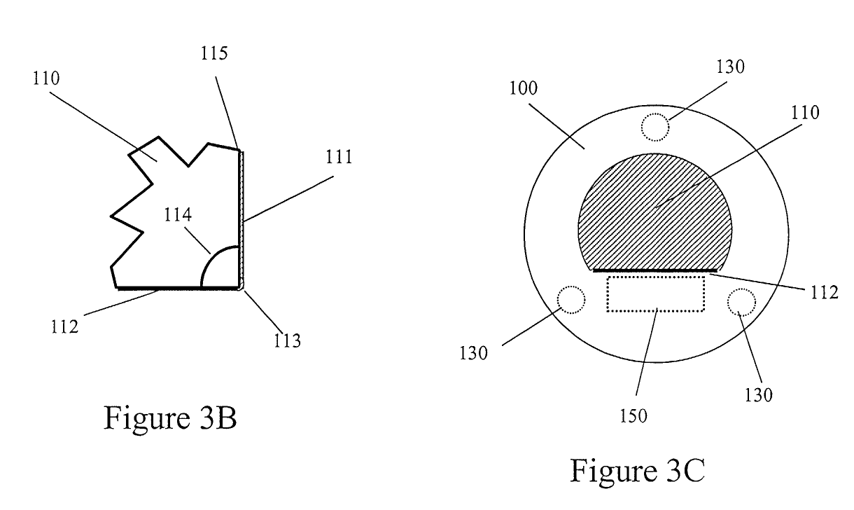

FIGS. 3A-3C show an embodiment of a Virtually Imaged Phased Array (VIPA) 300 according to the present invention. VIPA 300 may include three plates of optical material, plates 100, 110, and 120. Plates 100, 110, and 120 can be formed of any optical material including glass or other useful material. Plate 100 allows converging beam of light 140 to enter VIPA 300 through an area 150 of plate 100 called the “radiation window” and further provides support for plate 110. FIG. 3B shows a close up of bottom edge 113 of plate 110. The precisely shaped bottom side 112 of plate 110 allows input beam 140 to pass under its sharp edge 113 and enter gap 170 (forming an etalon) between plate 110 and plate 120. In some embodiments, gap 170 can be an air space on the order of 1.5 mm across, while other embodiments may comprise gap 170 filled with an optical material or of a differing size, depending on wavelength and desired dispersion. In some embodiments, used in precision applications, machine tolerance on gap 170 can be on the order of microns.

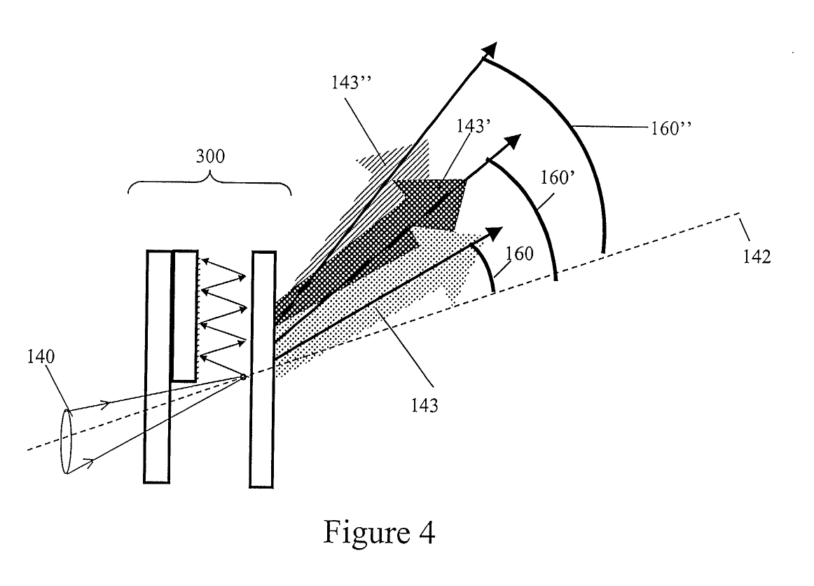

In etalon gap 170, the light undergoes multiple reflections between plate 120 and plate 110. In some embodiments, plates 120 and 110 may be held parallel to an order of 0.5 arc seconds (depending on the required precision of the resulting VIPA). Light transmitted through plate 120 on each reflection forms several orders of output beams. One such, output beam 143, is shown. The angle 160 of beam 143 depends on the wavelength of entering light 140. Plate 120 can be held to plate 100 with spacers 130. When a beam 140 containing multiple wavelengths of light is input to VIPA 300, it undergoes angular dispersion such that light of each wavelength exits in its own set of orders. Typically only one order would be used and for clarity, one order of output beam 143 is shown, exiting at angle 160 to optical axis 142. FIG. 4 shows one order of diffraction wherein multiple output beams 143, 143′, and 143″, each at different wavelength, exit at angles 160, 160′, and 160″, respectively, to optical axis 142.

Plate 100 may be formed of an optical material (e.g., a “glass” such as fused silica) by established optical manufacturing techniques and is preferably coated with antireflection (AR) coatings 101 and 102, the design and application of which are well known to the art, to allow for the highest efficiency in passing light through radiation window area 150. Plate 100 may also be shaped into a convenient form. FIG. 3C shows an end-on view (seen along the optical axis 142 from the perspective of entering light) where the plates 100, 110, and 120 have a round shape in order to fit into a system such as a dispersion corrector.

Both faces of plate 100 should be flat and polished in the area of the radiation window 150 in order to minimally aberrate or attenuate input beam 140. As an example, surfaces through which the beam will travel or from which it will be reflected might have roughness from about 60/40 to about 10/5 and flatness of about λ/2 to about λ/20 at 632.8 μm, or similar values, common to many optical systems. The entire second face 102 of plate 100 may be polished flat for convenient mounting of plate 110 to surface 102.

Plate 100 can be fabricated of a material chosen for best transmission of the optical beam 140 and can also be chosen based on considerations of weight, thermal properties, mechanical strength, or any other desirable property.

Plate 110 is formed with its second face 115, and one side 112 polished. Side 112 has an edge 113 (between side 112 and surface 115) of a radius, for example of about 5 μm, which allows for edge 113 to be sharp. Angle 114 between the side 112 and the surface 115 may be different from 90 degrees (for example about 85 to about 89 degrees). Second face 115 of second plate 110 is coated with reflective coating 111 such as a metallization (e.g., gold or silver) or a reflective thin film structure so as to have a reflectance near 100%. Plate 110 is fixed to plate 100 by, for example, bonding it with an epoxy, optical contact, or other means. The material of plate 100 may be chosen for any desired properties and although it may be an optical material, optical transmission may not be a significant consideration. In some embodiments, plate 100 and plate 110 are formed of the same or very similar material in order, for example, to reduce problems that may be associated with different thermal expansion characteristics.

Reflective coating 111 of plate 110 forms one surface of an etalon in the VIPA 300. In order to enter etalon gap 170, input beam 140 passes under sharp edge 113 of plate 110. For best efficiency, it should not be truncated or vignetted when reflected back off of partially transmitting coating 121 of plate 120 across etalon gap 170 to reflective coating 111. In some etalons, surfaces may be polished, for example, to about λ/50.

Plate 120 with both faces flat and polished and which can be shaped similarly to plate 100 is held at a desired distance from plate 100 by spacers 130 (or other means). Spacers 130 also precisely hold the spacing of etalon air-gap 170 to a desired thickness. In some embodiments, plate 100 and plate 120 are formed to provide a symmetrical final assembly. Spacers 130 provide mechanical support. In some embodiments, three spacers 130 can control the parallelism (or angle) between the faces coated with coatings 111 and 121 since three points define a plane. However, any means can be used to control a desired etalon gap 170, including one which compensates for changes in environmental temperatures, provides alignment adjustment, or includes any other function.

Plate 120 is polished and coated on its first face with a high but less than 100% reflectance material (properties can range, for example, from about 90% reflectance and about 10% transmittance to about 98% reflectance and about 2% transmittance), forming a partially transmitting coating 121, forming the second side of etalon 170. Coating 121 will be referred to as a “partially transmitting” coating. Plate 120 is polished and coated with an AR coating 122 on its second face to minimize loss of energy from outgoing optical beam 143. In some embodiments, it can be desirable to have partially transmitting coating 121 provide different reflectance over different parts of its surface, changing reflectance as a continuous gradient or possibly in a pattern of one or more steps.

A beam of light 140 is converging into a line-focus 141 parallel to the sharp edge 113 of plate 110. The beam of light 140 enters plate 100 of VIPA 300 through AR coated radiation window 150. Beam 140 reaches its line focus 141 near the position of partially transmitting coating 121 of the third plate 120. Beam 140 is directed into VIPA 300 such that beam of light 140 just misses edge 113 of plate 110 and has as small an angle of incidence with partially transmitting coating 121 as possible without any light missing reflective coating 111 on its first reflection from partially transmitting coating 121.

The light undergoes multiple reflections between reflective coating 111 and partially transmitting coating 121 in etalon gap 170. On each reflection (including the first), most light energy (nominally about 95%) remains in a reflected beam 144. A small amount of light energy (nominally about 5%) is contained in a transmitted beam 145 which exits through partially transmitting coating 121. On each of the multiple reflections, a new transmitted beam 145 is formed so that after multiple reflections, there are a multiplicity of transmitted beams 145. The multiplicity of beams optically interfere with each other to produce a collimated output beam 143 at an angle 160 to optical axis 142 in each order of diffraction. Angle 160 depends on the wavelength of light.

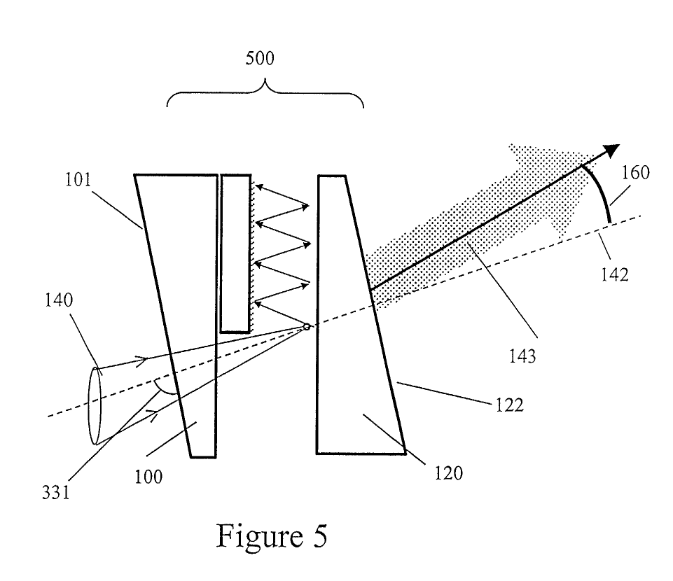

FIG. 5 shows another embodiment of the invention. In FIG. 5, plates 100 and 120 have surfaces that are not parallel. The surfaces, coated with coatings 101 and 122, are formed at angle of incidence 331. This can aid in avoiding stray light due to internal reflections.

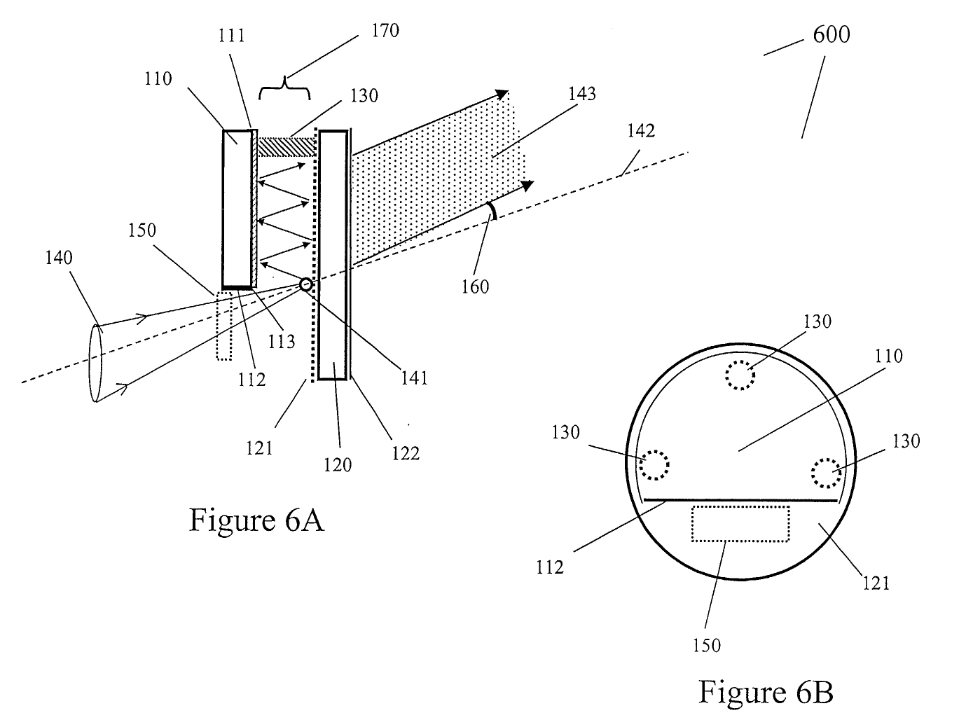

FIGS. 6A and 6B show another embodiment of the invention. In FIGS. 6A and 6B, plate 100 shown in FIG. 3A is omitted and plate 110 (forming surface 111 of etalon gap 170) is held directly to plate 120 by spacers 130. FIG. 6B shows a view along optical axis 142 looking from the direction of light 140 entering VIPA 300. Partially transmitting coating 121 on plate 120 forms the second surface of etalon 170. Spacers 130 hold plates 110 and 120 together and light 140 travels the same paths 140, 143, and 145 shown in FIG. 3A. The embodiment shown in FIGS. 6A and 6B eliminates weight and the small losses associated with the light travelling through plate 100.

The overall shape of the VIPA may be such so as to fit into any package by changing the overall shape of plates 100, 110, and 120 (shown as round in FIGS. 3C and 6B). In some embodiments, stray light or other optical considerations can be accommodated by blackening or otherwise coating or etching various surfaces of plates 100, 110, and 120, including limiting apertures for light beams 140 or 143 entering or leaving VIPA 300 or 500 or 600.

The embodiments described above are exemplary only and are not intended to be limiting. One skilled in the art may recognize various possible modifications that are intended to be within the spirit and scope of this disclosure. As such, the invention is limited only by the following claims.

We claim:

1. An optical device comprising:
a reflective plate; and
a partially transmitting plate positioned relative to the reflective plate to form an etalon gap.

2. The device of claim 1, wherein the reflective plate has a sharp lower edge such that an input light beam may pass the lower edge and strike the partially transmitting plate so as to undergo multiple reflections between the reflective and partially transmitting plates.

3. The device of claim 1 wherein the sharp lower edge of the reflective plate is formed by polishing a lower side of the reflective plate.

4. The device of claim 2 wherein the edge of the reflective plate is cut at an enclosed-angle other than 90 degrees.

5. The device of claim 1 wherein the reflective plate is supported by a transmitting plate capable of admitting a light beam into the etalon gap.

6. The device of claim 1, further including at least one spacer separating the reflective plate and the partially transmitting plate.

7. The device of claim 6 wherein the spacer is adjustable.

8. The device recited in claim 1 where the etalon gap is filled with an optical material.

9. The device of claim 1 wherein the reflective plate is formed by depositing a metallization on a plate of optical material.

10. The device of claim 1 wherein the reflective plate is formed by depositing a thin film structure on a plate of optical material.

11. The device of claim 1 wherein the partially transmitting plate is formed by depositing a thin metallization on one face of a plate of optical material and an antireflective coating on the remaining face.

12. The device of claim 1 wherein the partially transmitting plate is formed by depositing a thin film structure on one face of a plate of optical material and an antireflective coating on the remaining face.

13. The device of claim 1 wherein the partially transmitting plate has a transmission which varies as a function along the plate surface.

14. The device of claim 13 wherein the function of plate transmission is defined by one or more steps.

15. An optical device comprising
a reflective plate supported by
a transmitting plate capable of admitting light directed at
a partially transmitting plate positioned relative to the reflective plate to form an etalon gap.

16. The device of claim 15, wherein the reflective plate has a sharp lower edge such that an input light beam may pass the lower edge and strike the partially transmitting plate so as to undergo multiple reflections between the reflective and partially transmitting plates.

17. The device of claim 16 wherein the sharp lower edge of the reflective plate is formed by polishing a lower side of the reflective plate.

18. The device of claim 16 wherein the edge of the reflective plate is cut at an enclosed-angle other than 90 degrees.

19. The device of claim 15, further including at least one spacer separating the transmitting plate and the partially transmitting plate.

20. The device of claim 19 wherein the spacer or spacers are adjustable.

21. The device as recited in claim 15 where the “etalon gap” is filled with an optical material.

22. The device of claim 15 wherein the reflective plate is formed by depositing a metallization on a plate of optical material.

23. The device of claim 15 wherein the reflective plate is formed by depositing a thin film structure on a plate of optical material.

24. The device of claim 15 wherein the partially transmitting plate is formed by depositing a thin metallization on one face of a plate of optical material and a thin film structure on the other face.

25. The device of claim 15 wherein the partially transmitting plate is formed by depositing one thin film structure on one face of a plate of optical material and another film structure on the other face of the plate of optical material.

26. The device of claim 15 wherein the transmitting plate is formed by depositing a thin film structure on both faces of a plate of optical material.

27. The device of claim 15 wherein the partially transmitting plate has a transmission which varies as a function along the plate surface.

28. The device of claim 27 wherein the function of plate transmission is defined by one or more steps.

29. A method of manufacturing an optical etalon for use as a Virtually Imaged Phased Array, comprising:
forming a reflective plate;
forming a partially transmitting plate; and
positioning the reflective plate relative to the partially transmitting plate such that a light beam can be reflected between the partially transmitting plate and the reflective plate multiple times.

30. The method of claim 29, wherein forming a reflective plate comprises coating an optical material with a highly reflective substance.

31. The method of claim 30, wherein the highly reflective substance is a metal.

32. The method of claim 30 wherein the highly reflective substance is a thin film structure.

33. The method of claim 29, wherein forming a partially transmitting plate comprises coating a plate of optical material with a partially transmitting substance on one face and an antireflective material on the remaining face.

34. The method of claim 30 wherein the partially transmitting substance is a thin metallization.

35. The method of claim 33 wherein the partially transmitting substance is a thin film structure.

36. A method of manufacturing an optical etalon for use as a Virtually Imaged Phased Array, comprising:
forming a transmitting plate;
forming a reflective plate;
forming a partially transmitting plate;
attaching the reflective plate to a face of the transmitting plate; and
positioning the reflective plate relative to the partially transmitting plate such that a light beam transmitted through the transmitting plate can be reflected between the partially transmitting plate and the reflective plate multiple times.

37. The method of claim 36 wherein
forming a reflective plate comprises
coating an optical material with a highly reflective substance.

38. The method of claim 37, wherein the highly reflective substance is a metal.

39. The method of claim 37 wherein the highly reflective substance is a thin film structure.

40. The method of claim 36, wherein forming a partially transmitting plate comprises coating a plate of optical material with a partially transmitting substance on one face and an antireflective material on the remaining face.

41. The method of claim 37 wherein the partially transmitting substance is a thin metallization.

42. The method of claim 40 wherein the partially transmitting substance is a thin film structure.
